(19) United States
(12) Patent Application Publication
(10) Pub. No.: US 2001/0034632 A1
(43) Pub. Date: Oct. 25, 2001

(54) Research and development process

(76) Inventor: William T. Wilkinson, Salem, NJ (US)

Correspondence Address: Ratner & Prestia, P.O. Box 7228, Wilmington, DE, 19803, US

(21) Appl. No.: 09/771,286

(22) Filed: Jan. 26, 2001

Related U.S. Application Data
(60) Provisional application No. 60/178,677, filed on Jan. 28, 2000.

(51) Int. Cl. G06F 17/60

(52) U.S. Cl. 705/8; 705/36

(57) ABSTRACT

A process for conducting research and development on a project comprises the steps of establishing a competition between at least two identifiably distinct R&D teams to work on the project, including at least one team leader responsible for leading members of each team and one project manager to oversee the competition, and including providing an incentive for winning the competition. As each team works on the project and develops a proposed solution, their progress is periodically evaluated to determine if any team can be declared a winner or can be eliminated from the competition. A winning solution is designated and the incentive is awarded the incentive to the winning team. The process preferably involves an internal R&D team competing against an external R&D team.

### CROSS-REFERENCE TO RELATED APPLICATIONS

This invention claims priority based upon United States Provisional Application Ser. No. 60/178,677, titled “Technology and Product Research and Development Management Process,” filed on Jan. 28, 2000, by the common inventor of this invention, and incorporated herein by reference.

### TECHNICAL FIELD

This invention relates to research and development, and more particularly to an improved research and development project.

### BACKGROUND OF THE INVENTION

Research and development (R&D) is a critical process in many organizations. Typical R&D processes may be inherently risky, wherein a single organization bears the entire R&D risk and expense. Furthermore, some traditional R&D processes, particularly R&D for new technologies and products, have occasionally been criticized a number of reasons. Among such criticisms are that R&D is slow, time-consuming, expensive, inefficient, insular (resistant to and exclusive of outside ideas), bureaucratic rather than entrepreneurial, and non-competitive. R&D in some organizations may be marked by large budget overrides with little or no accountability on progress, productivity, and profitability. The R&D process also may lack incentives or rewards for the organization or its participants.

Consequently, R&D in many organizations is only marginally productive, producing few successful products as compared to the total number of R&D projects undertaken. Thus, some R&D processes have an unacceptably low return on investment, because only a relatively small amount of revenue is generated from a relatively large expenditure on R&D. R&D may also suffer from a lack of liquidity for R&D assets, as there has traditionally been little or no direct marketplace for intellectual property and no generally accepted valuation system for such assets.

Consequently, not all R&D results in the development of technologies and products that are considered top-quality. Organizations with slower-moving R&D processes may be vulnerable to faster competitors. Reasons for poor R&D performance may sometimes arise from laziness, inertia, various fears, and/or the “not-invented-here” syndrome. The various fears may include fear of change, such as fear of employees losing their job if work on a project ends, or fear of a new product replacing an existing product. In other instances, there may be a fear of being identified with a new product that fails. The “not-invented-here” syndrome is marked by the pride, jealousy, greed, and egos of individuals who put personal recognition above organizational success, and thus resist external help or partnerships to find solutions. Reluctance to seek external help may also arise from fear, such as a general fear of sharing ideas with competitors, or fear on the part of management in loss of control and power to an outside source. In other cases, the reluctance to seek outside help may be purely monetary, resulting from not wanting to pay outside parties for solutions.

Thus, in some organizations, current R&D processes, rather than fostering and promoting change, are one of the greatest barriers to change. Corporations are constantly in search of ways to improve the return on R&D investment to meet today's competitive environment.

### SUMMARY OF THE INVENTION

In accordance with this invention, there is provided a process for conducting research and development (R&D) on a project. The process comprises establishing a competition between at least two identifiably distinct R&D teams to work on the project, including at least one team leader responsible for leading members of each team and one project manager to oversee the competition, and including providing an incentive for winning the competition. Each team works on the project, develops a proposed solution, and progress is periodically evaluated to determine if any team can be declared a winner or can be eliminated from the competition. At some point, a winning solution and a winning team are designated and the incentive is awarded to the winning team. If a winning solution includes a portion of a first team's solution and a portion of a second team's solution, a percentage of the incentive may be awarded to each of the first and second teams.

Preferably, at least one of the teams is an external team and at least one of the teams is an internal team, although the teams may be all internal or all external. A plurality of teams may be allowed to bid to enter the competition, and the teams to participate in the competition may be chosen based upon bids submitted by those teams. The competition may be underwritten by a first organization, while an independent third party provides the evaluation of the teams' progress to the first organization for review and consideration.

### BRIEF DESCRIPTION OF DRAWINGS

FIG. 1 is a flowchart detailing the steps of an exemplary process of this invention.

### DETAILED DESCRIPTION OF INVENTION

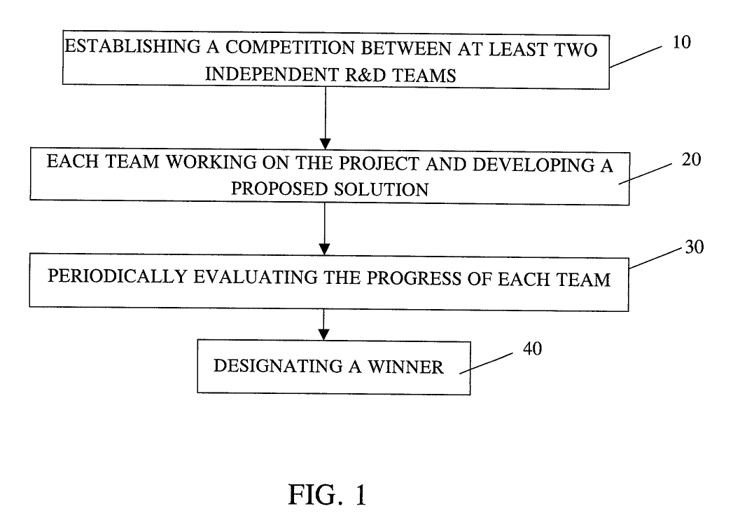

The invention will next be illustrated with reference to FIG. 1. FIG. 1 is intended to be illustrative rather than limiting and is included herewith to facilitate the explanation of the process of this invention. FIG. 1 shows a flowchart depicting an exemplary process of this invention.

Typically, after planning and selecting technologies and products to pursue, an organization may first research existing and developmental technologies and products, such as through the use of computerized/web search services. Existing technologies and products may be procured by licensing, acquisitions and/or mergers. Projects still needing R&D are prioritized and schedules, time tables, and budgets are projected. The R&D projects may be funded all internally or through a partnership with one or more external sources to reduce some of the risk and/or expense of the project.

Then, as shown in FIG. 1 in step 10, two or more competitive R&D teams are established, preferably one internal team and one external team, each team having a team leader. A competitive bidding process may be used to choose each external R&D team. A R&D Project manager oversees the competition and reports to the head of R&D. An incentive program of awards, bonuses, and/or prizes for best, fastest and/or lowest-cost R&D solution is established. Also, an independent measurement and evaluation system is established to measure, compare and evaluate the progress of the R&D teams and to periodically report the results to the team leaders, project R&D manager, and head of R&D. The measurement and evaluation system is preferably externally operated, such as by a consulting firm.

The teams then begin conducting research and develop the technology and/or products, as shown in step 20, and the progress of the teams is periodically evaluated, as shown in step 30, typically by the R&D project manager. The R&D project manager may further consider other external solutions, such as licensing and/or acquisition, and may use outside services, such as computer/web listing services to monitor possible solutions. At any point, once it becomes apparent that a solution being prepared by one of the R&D teams is clearly inferior to the others, that team may be eliminated from the competition. Ultimately, as shown in step 40, a winning solution and winning team is designated. The decision on a best R&D solution is preferably made by the R&D Project managers and the head of R&D. Depending on how far along in the process each losing team has progressed, each non-chosen solution may be packaged for sale or licensing to another party. The winning team may receive awards, bonuses, and the like as special compensation. Patents and other intellectual property may be procured to protect not only the winning R&D solution, but also the non-chosen solutions, particularly if the non-chosen solutions are slated for future sale or licensing.

The chosen solution is typically retained by the organization for further development, but in some circumstances it may also be licensed out and/or sold in part (to a partner or through IPO) or in whole (through a divestiture). Such circumstances may arise if, during the R&D process, it is determined that the winning solution is not within the core competency of the organization, or if the organization is not in the business of manufacture and marketing, but R&D only.

The process provides advantages over prior processes in the art because R&D performed for a single business entity traditionally comprises a single R&D effort focused on each technology or product. Although multiple R&D efforts may progress in parallel to attack individual aspects of the same problem, R&D efforts typically avoid duplication of effort. A single R&D effort, however, creates a noncompetitive process condition. Multiple R&D efforts, on the other hand, create competitive processes which may spur innovation. The process of this invention therefore draws upon competition as the engine for accelerating the R&D process.

The process creates a revolutionary, new, more dynamic, and more effective R&D process. The process also typically includes a strategic planning element that determines the organization's markets, goals and priorities for its technologies and products. Using the process may help define the optimum technology or product solution, arrive at that solution within budget and time constraints, minimize development time and expense, maximize return on investment from R&D, and maximize the quality of the product or technology solution. Identifying the clearly superior R&D solution as early as possible, regardless of origin, is fostered by actively seeking external solutions, such as licensing, acquisition, or co-development and partnering with other organizations or individuals/inventors, on a regular basis throughout the competition.

To achieve these goals, the process typically includes replacing bureaucratic managers with entrepreneurial, innovative managers, and assures that the managers stay entrepreneurial by introducing the competitive structure to all R&D projects. As used herein, the term “project” is used to refer to the motivating purpose of the R&D, such as to solve a problem or fill a need in the marketplace. The project may comprise developing a new technology or a new product, or both, or improving an existing product or technology. Although the competition may be all-internal, and may be between or among teams working on the same technology or product or on different technologies or products, the competition is preferably between at least one internal and at least one external R&D team, each working on the same technology or product. The term “internal” as used herein means that the members of the team are employees of the organization sponsoring the R&D. “External” means that the members of the team are independent contractors or are employed by a third party other than the organization sponsoring the R&D. Hybrid teams comprising a combination of employees and external members may also be part of the competition.

The preferred embodiment of at least one external team and at least one internal team avoids many of the problems of the prior art. For example, fear of change, “not-invented-here,” and other considerations that typically may negatively influence an all-internal R&D program, are avoided by using an external team. Furthermore, the internal team may also shed their fears and other negative influences in the spirit of competition with the external team. Internal pride, as well as the incentive “carrot” to the winner, may also fuel extra hard work on the part of the internal team. The external team, on the other hand, brings a fresh perspective to the problem, and brings the hunger of wanting to perform well so that they will be invited back to future competitions.

The R&D process of this invention therefore comprises a single entity establishing at least two identifiably distinct, competitive R&D teams to work on the same R&D project to solve the same R&D problem. The entity may be a corporation, joint venture, government, university, or any type of research and development organization. The R&D problem may be open-ended, such that the teams may pursue any technology or product that they can dream up to solve the given problem, or closed-ended such that the teams are assigned a specific technology or product to research and/or develop. The amount of restrictions on the project may be anywhere on the continuum between open-ended and closed-ended. Both teams may be assigned to pursue the same technology or product, or each team may be assigned a different technology. The teams may comprise at least one internal team and at least one external team, or may comprise all internal teams or all external teams. There may be only two teams, or any number of teams more than two. The identifiably distinct teams are preferably completely independent from one another, but there may optionally be some amount of cooperation or information-sharing between or among the teams.

The process may use competitive bidding, in particular to select external R&D teams, where the successful bidder is chosen based upon criteria such as lowest cost, shortest development time, and proposed solution. Thus, a first step in the process may comprise a plurality of teams bidding to enter the competition, with the organization then choosing which teams will be allowed to enter based upon bids submitted by those teams. For example, a relatively large number of internal teams and external teams may be provided with the project description and given a relatively short timeframe to proposed solution. Based on these bids, the relatively large number may be winnowed down to a relatively smaller number of teams, perhaps only two, to continue forward with the competition.

Each R&D team has at least one leader that is responsible for running the team. An incentive may be provided to reward the R&D team that produces the chosen solution, based upon development time, expense, and perceived quality of the solution. The reward may be a fixed amount, but is preferably variable and dependent upon the speed and expense of the solution as compared to the competitively proposed solution. The rewards may be of any type, such as cash, stock options, or prizes, such as all-expenses-paid vacations, automobiles, and the like. The rewards may be higher for the team leaders than the team members. The process may also comprise a penalty system designed to penalize the R&D teams for budget overruns, excess development time, poor quality solutions and the like. Penalties may include a reduction in compensation or disqualification from participation in future R&D competitions. For example, each team leader and/or team member may receive a first amount of incentive bonus just for participating in the competition, whether their team's solution wins or not. That first amount of incentive may be eliminated or reduced as a penalty. An external team may be a representative of a third party company, and that team may be penalized by the third party company being disqualified from solicitation of bids to participate in future competitions.

R&D Project Managers are responsible for managing the progress of the competing teams. The Project Manager is responsible for securing the best solution, either from the team competition and/or from licensing or acquiring a solution from other parties. Several Project Managers may then be managed by a head of R&D responsible for all R&D in the organization.

In monitoring the progress of the contest, independent performance tracking & evaluation is desirable. Thus, an R&D reporting system is established as part of the process. The reporting system may be operated internally, but is preferably operated externally by an independent consultant, such as a CPA or management consulting firm. Periodic reviews are conducted and distributed to the team leaders, R&D Contest Managers, and the head of R&D. Reporting criteria include progress of each team, expenses to date, revenue expectation, and the merits of the proposed solution. The periodic reports may be used to determine at various stages of the process whether there is a clear winner or whether any one of the teams should be eliminated from the competition.

For example, the amount of time allotted to produce the bid may be insufficient to fully develop all the proposed solutions on equal footing. Some solutions may need more time to more fully evaluate their potential. Thus, some teams may be provisional teams allowed to continue long enough to further “flesh-out” their solution for further evaluation. At some point, however, it may be clear that there is no benefit to further allowing a provisional team to go forward, either because of the cost or time involved, or because of the comparative success and simplicity of one or more of the solutions of competing teams. Similarly, if three teams are on equal footing after the bid stage and are allowed to proceed, it may become clear after several months that the winning team will be one of two, in which case the third team can be dropped from the competition.

The process may take advantage of external data services, such as by using computerized auction and information exchange sources to locate, license, and/or acquire new products/technologies, to create a market for new or existing technologies/products, to find partners, and/or to establish a fair market value for a given product/technology. The best R&D technology/product solution may be determined by considering all internal and external solutions/results. This may involve ongoing consideration of product/technology purchase and licensing options, as compared to the solutions being developed by competing teams. The determination may also involve combining selected parts or aspects of each team's solution to produce a better solution than either team's solution alone. In such case, each team may be awarded a portion of the incentive based upon the percentage of the overall solution provided by that team.

A number of techniques may be used at any point in the R&D process to reduce expense, risk, and/or R&D time, to generate or increase revenues from a given technology/product, and/or to increase return on investment from a given product or technology. These techniques may include licensing or purchasing other products or technologies; establishing joint ventures, such as with makers of existing products or with venture capital firms and/or strategic partners, to develop new product or technologies; licensing or assigning the organization's existing products or technologies; making Initial Public Offerings (IPOs) to spin off pending R&D projects at any stage in the development process or to spin off existing or completed products or technologies; or employing a patent valuation system or service to determine the fair market value of a given technology or product. Elevating an R&D representative to a Board of Directors position may be one way of making R&D an integral part of strategic planning.

Various financial services may also be helpful in performing the process. For example, the organization may use a product/technology valuation process to determine the fair market value of intellectual property and business. Internet search services may be used for locating potential licensors, partners, buyers of technologies and products. Internet search services may further be used to solicit bids to help determine the value of products/technologies. Financial services may also be used to license and/or sell-off non-retained technologies and products. The revenue stream produced by such a sell-off may help offset R&D expenses. The invention may be practiced by providing computer software as may be desired to provide the invention as a computerized service, such as for monitoring the progress of the teams, logging data for evaluation by the tracking system, and the like.

The invention may also benefit from the use of corporate venture capital funds. As an incentive, R&D managers may be paid from financial sources such as outside companies or from internal venture capital funds managed by the organization itself. As part of the goal setting process, intellectual property strategists may be used in the top planning stage to determine research and development goals.

The R&D process of this invention is appropriate for all types of organizations engaged in R&D efforts. It may be used for existing or new technologies and products. Organizations benefiting from this process may be public or private, and may include but are not limited to corporations, partnerships, and sole proprietorships, governments, universities, medical institutions, charitable institutions, and industry associations. The process of this invention generally accelerates R&D, by producing technologies and products faster because of the competition among teams. The process also improves quality by producing better products and technologies, again because of the competition to have the best quality solution. The process also improves productivity, and by definition produces more products and technologies, even if non-chosen products and technologies are ultimately not pursued by the organization initially sponsoring the R&D. By making the R&D process more efficient and more productive, the process also reduces overall R&D expenses and reduces the overall time and energy spent per product. By producing more and better products faster, the process reduces overall competitive risk and increases ROI from each technology or product, increasing overall the total revenues and profitability of R&D.

In summary, therefore, a preferred process of this invention may include any or all of the following steps:

1. Elevating R&D to a Board of Directors position that is an integral part of strategic planning;

2. Planing and selecting technologies and products on which to conduct research and development;

3. Utilizing computerized/web search services to locate technologies & products;

4. Procuring existing technologies and products, by licensing, acquisitions and/or mergers;

5. Prioritizing technologies & products;

6. Establishing R&D schedules and/or time tables;

7. Establishing project budgets;

8. Reducing the risk and/or expense of certain projects by using outside financial sources;

9. Funding projects either all internally or by partnering with outside sources;

10. Establishing for a given project two or more competitive teams, preferably one internal and one external team, each team with a team leader or captain;

11. Establishing a project R&D manager who manages the team captains and reports to the head of R&D;

12. Using competitive bidding process to choose external R&D teams;

13. Establishing an incentive program of awards, bonuses, and/or prizes for the best, fastest, and/or lowest-cost R&D solution;

14. Establishing an independent measurement and evaluation system, preferably external to the organization, such as a CPA consulting firm, to measure, compare, and evaluate the progress of R&D teams and periodically report the results to the team leaders, R&D project manager, and head of all R&D;

15. The teams researching and developing the technology and products;

16. The R&D project manager monitoring the progress of the teams;

17. The R&D project manager considering other external solutions, such as licensing and/or acquisition;

18. The R&D project manager using outside services, such as computer/web listing services to monitor possible solutions;

19. When one team's solution is adjudged the best, or another team's solution is adjudged clearly inferior to all other solutions, stopping the inferior team;

20. The R&D team managers and the head of R&D making the decision on a best R&D solution;

21. Providing awards, bonuses, and the like, to the winning team;

22. Filing patents and procuring other intellectual property, such as trademarks, copyrights, domain names, and the like, to protect the R&D solutions (winning and/or losing);

23. Deciding with respect to the winning solution to:

a. Keep and/or retain it;

b. License it out;

c. Sell the technology and/or product in whole (divest it); and/or

d. Sell the technology and/or product in part (through a partner, joint venture, IPO, or the like);

24. Using a product and/or technology valuation process to determine the fair market value of the intellectual property and the business;

25. Using Internet services to locate potential licensors, partners, buyers of technologies and/or products;

26. Using Internet services to solicit bids to help determine the value of the products and/or technologies;

27. Using financial sources to license and/or sell-off non-retained technologies and products, to produce a revenue stream and thereby reduce or eliminate R&D expense.

Although illustrated and described herein with reference to certain specific embodiments, the present invention is nevertheless not intended to be limited to the details shown. Rather, various modifications may be made in the details within the scope and range of equivalents of the claims and without departing from the spirit of the invention.

What is claimed:

1. A process used by an organization for conducting research and development (R&D) on a project, the process comprising the steps of:
(a) establishing a competition between at least two identifiably distinct R&D teams to work on the project, each team including at least one team leader responsible for leading members of each team;
(b) identifying a project manager to oversee the competition;
(c) providing an incentive for winning the competition;
(d) each team working on the project and developing a proposed solution;
(e) periodically evaluating the progress of each team to determine if any team can be declared a winner or can be eliminated from the competition;
(f) designating a winning solution and a winning team, and awarding the incentive to the winning team.

2. The process of claim 1 wherein at least one of the teams is an external team.

3. The process of claim 2 wherein at least one of the teams is an external team and at least one of the teams is an internal team.

4. The process of claim 2 wherein all of the teams are external teams.

5. The process of claim 1 wherein all of the teams are internal teams.

6. The process of claim 1 wherein at least one of the teams is a hybrid team comprising both internal and external members.

7. The process of claim 1 further comprising prior to step (a), allowing a plurality of teams to bid to enter the competition, and choosing, based upon bids submitted by those teams, the teams to participate in the competition.

8. The process of claim 1 further comprising an independent third party providing an evaluation of the teams' progress to the first organization.

9. The process of claim 1 wherein step (f) comprises designating a winning solution that includes a portion of a first team's solution and a portion of a second team's solution, and awarding a percentage of the incentive to each of the first and second teams.

10. The process of claim 1 further comprising comparing the proposed solutions developed by the teams against solutions available through licensing and purchase opportunities.

11. The process of claim 1 further comprising licensing or selling off technology related to a losing solution developed in the competition.

12. The process of claim 1, wherein the organization has a Board of Directors and the process is carried out by an R&D division of the organization, the process further comprising including a representative of the R&D division as a member of the Board of Directors.

13. The process of claim 1, wherein the process comprises prior to step (a), the steps of:
planning and selecting one or more projects to pursue, each project comprising a technology, a product, or both, on which to conduct the research and development;
prioritizing the selected projects;
establishing a schedule, a time table, or both for performing the R&D; and
establishing a budget for each project.

14. The process of claim 1, wherein the process comprises funding each project using a source of funds internal or external to the organization.

15. The process of claim 1, wherein project manager reports to a head of R&D.

16. The process of claim 1, wherein the winning solution and winning team are designated by a committee comprising each project manager and the head of R&D.

17. The process of claim 1, comprising procuring one or more forms of intellectual property for at least the winning solution, and optionally for one or more losing solutions.

18. The process of claim 17, further comprising using a valuation process to determine a fair market value for a business based upon the winning solution and the intellectual property associated therewith.

19. The process of claim 18 wherein the valuation process comprises using a global computer information network to solicit bids for the business.

20. The process of claim 1, further comprising using a global computer information network to locate potential licensors, partners, or buyers for the winning or losing solution.

21. A process for conducting research and development (R&D) on one or more projects, the process used by organization having a head of R&D, the process comprising:
(a) including the head of R&D as a member of the Board of Directors;
(b) planning and selecting the one or more projects, each project comprising a technology, a product, or both, on which to conduct the research and development;
(c) prioritizing the selected one or more projects;
(d) establishing a schedule, a time table, or both for performing the R&D for each project; and
(g) establishing a budget for each project and determining whether the budget for each project will be funded entirely using internal sources of capital or by using one or more external sources of capital;
(h) establishing a competition between at least two identifiably distinct R&D teams to work on each project, wherein at least one of the teams is an external team and at least one of the teams is an internal team, each team including at least one team leader responsible for leading members of each team, wherein establishing the external time comprises allowing a plurality of external teams to bid to enter the competition, and choosing, based upon the bids submitted by the plurality of teams, the at least one team to participate in the competition;
(i) identifying a project manager to oversee the competition for each project, each project manager reporting to the head of R&D;
(j) providing an incentive for winning the competition;
(k) each team working on the project and developing a proposed solution;
(l) periodically evaluating the progress of each team to determine if any team can be declared a winner or can be eliminated from the competition, including considering a progress report prepared by an independent third party regarding each team's performance;
(m) comparing the proposed solutions developed by the teams against solutions available through licensing and purchase opportunities;
(n) a committee comprising the head of R&D and the project managers for a plurality of the projects designating a winning solution and a winning team for each project;
(o) awarding the incentive to the winning team for each project;
(p) procuring one or more forms of Intellectual property for at least the winning solution for each project, and optionally for one or more losing solutions for each project;
(q) using a valuation process to determine a fair market value for a business based upon each winning solution and the intellectual property associated therewith;
(r) for each project, determining whether to further develop the project internally, license rights related to the project to a third party, or sell the project in part or in whole to a third party.

22. The process of claim 21, further comprising using a global computer information network to locate potential licensors, partners, or buyers for the winning or losing solution and to solicit bids for the business as part of the valuation process.
